(19) United States
(12) Patent Application Publication
(10) Pub. No.: US 2015/0054692 A1
(43) Pub. Date: Feb. 26, 2015

(54) ANTENNA MODULE AND ELECTRONIC DEVICE INCLUDING THE SAME

(71) Applicant: SAMSUNG ELECTRO-MECHANICS CO., LTD., Suwon-Si (KR)

(72) Inventors: Kang Ryong Choi, Suwon-Si (KR); Hyung Jin Jeon, Suwon-Si (KR); Sung Yong An, Suwon-Si (KR); Kang Heon Hur, Suwon-Si (KR); Jung Wook Seo, Suwon-Si (KR)

(73) Assignee: SAMSUNG ELECTRO-MECHANICS CO., LTD., Suwon-Si (KR)

(21) Appl. No.: 14/463,516

(22) Filed: Aug. 19, 2014

(30) Foreign Application Priority Data
Aug. 20, 2013 (KR) 10-2013-0098749

(51) Int. Cl. H01Q 1/24; H01Q 7/06; H01Q 7/00

(52) U.S. Cl. CPC H01Q 1/243; H01Q 7/00; H01Q 7/06
USPC 343/702

(57) ABSTRACT

There is provided an antenna module formed to correspond to an opening formed in a frame, including: a coil conductor part disposed in the opening of the frame when viewed on a plane; and a substrate including the coil conductor part formed thereon. The coil conductor part is wound outside a non-conductive portion of the substrate.

### CROSS-REFERENCE TO RELATED APPLICATION

This application claims the benefit of Korean Patent Application No. 10-2013-0098749 filed on Aug. 20, 2013, with the Korean Intellectual Property Office, the disclosure of which is incorporated herein by reference.

### BACKGROUND

The present disclosure relates to an antenna module and an electronic device including the same.

Recently, radio frequency identification (RFID) systems, such as near field communications (NFC) systems, have been used in electronic devices such as a mobile phones, smartphones, tablet personal computers (PCs), laptop computers, and the like.

Such an RFID system is an example of an antenna system intended for transmitting and receiving signals, and the antenna system is implemented by a module including a coil conductor.

When the antenna system is applied to a metal case, magnetic flux passing through a metal surface may induce an Eddy current within the metal case, such that a repulsive magnetic field is generated in accordance with Lenz's law. Here, a recognition distance of the antenna system for communications may be decreased due to the repulsive magnetic field.

In Patent Document 1, a conductor layer includes an opening and a slit part formed between the opening and an edge of the conductive layer. When a current flows in a coil conductor, it flows around the opening and is circulated to the edge of the conductive layer through an edge of the slit part.

In Patent Document 1, since the slit part is formed in the conductive layer, a degree of freedom in a design of the conductive layer is low, and a separate injection-molding structure covering a slit is required in order to prevent the introduction of a contaminant such as dust.

### RELATED ART DOCUMENT

(Patent Document 1) Japanese Patent No. 4687832

### SUMMARY

An aspect of the present disclosure may provide an antenna module enabling communications by using another module corresponding to an opening of a metal conductor cover without expanding the opening, and an electronic device including the same.

According to an aspect of the present disclosure, an antenna module formed to correspond to an opening formed in a frame may include: a coil conductor part disposed in the opening of the frame when viewed on a plane; and a substrate including the coil conductor part formed thereon.

The coil conductor part may be wound outside a non-conductive portion of the substrate.

The coil conductor part may be exposed to an upper portion of the opening.

The substrate may further include a magnetic material sheet.

The magnetic material sheet may contain at least one of Ni—Zn—Cu-based ferrite, Mn—Zn-based ferrite, and Ni, Fe, Co-based amorphous metals.

The magnetic material sheet may contain at least one of chlorinated polyethylene (CPE), polypropylene (PP), ethylene propylene rubber (EPDM), natural rubber (NR), nitrile butadiene rubber (NBR), polyvinyl chloride (PVC), a polyimide-based resin, and a polyester-based resin.

The coil conductor part may be formed in a camera module.

The coil conductor part may be formed in a microphone module.

The coil conductor part may be formed in a light source part.

The frame may be formed of a metal.

According to another aspect of the present disclosure, an electronic device may include: a frame having an opening formed therein; an antenna module disposed in the opening when viewed on a plane and including a coil conductor part transmitting or receiving signals; and an electronic component module having the coil conductor part formed therein and blocking a space of the opening from being in communication with an internal space of the frame.

The coil conductor part may be wound outside a non-conductive portion of the substrate.

The coil conductor part may protrude and be exposed from the opening.

The antenna module may further include a magnetic material sheet formed on the substrate.

The magnetic material sheet may contain at least one of Ni—Zn—Cu-based ferrite, Mn—Zn-based ferrite, and Ni, Fe, Co-based amorphous metals.

The magnetic material sheet may contain at least one of chlorinated polyethylene (CPE), polypropylene (PP), ethylene propylene rubber (EPDM), natural rubber (NR), nitrile butadiene rubber (NBR), polyvinyl chloride (PVC), a polyimide-based resin, and a polyester-based resin.

The electronic component module may include a camera module, a light source part, or a combination thereof.

The electronic component module may include a microphone module.

The electronic component module may include an antenna module in which an antenna conductor part is injection-molded using a magnetic material.

The frame may be formed of a metal.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exploded perspective view schematically illustrating an electronic device according to an exemplary embodiment of the present disclosure;

FIG. 2 is a schematic exploded perspective view of the electronic device having an antenna module according to an exemplary embodiment of the present disclosure installed therein;

FIG. 3 is a schematic perspective view of the antenna module according to an exemplary embodiment of the present disclosure;

FIG. 4 is a cross-sectional view taken along line A-A′ of FIG. 3;

FIG. 5 is a schematic perspective view of a camera module according to a first exemplary embodiment of the present disclosure;

FIG. 6 is a schematic exploded perspective view of the camera module of FIG. 5;

FIG. 7 is a schematic enlarged view of a first modified example of the camera module according to a first exemplary embodiment of the present disclosure;

FIG. 8 is a schematic enlarged view of a second modified example of the camera module according to a first exemplary embodiment of the present disclosure;

FIG. 9 is a schematic enlarged view of a third modified example of the camera module according to a first exemplary embodiment of the present disclosure;

FIG. 10 is a schematic perspective view of a camera module according to a second exemplary embodiment of the present disclosure;

FIG. 11 is a schematic perspective view of a camera module according to a third exemplary embodiment of the present disclosure;

FIG. 12 is a schematic perspective view of an electronic device in which a camera module according to a fourth exemplary embodiment of the present disclosure is used;

FIG. 13 is a schematic perspective view of the camera module according to a fourth exemplary embodiment of the present disclosure; and

FIG. 14 is a cross-sectional view taken along line B-B′ of FIG. 12.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein.

Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

### Electronic Device

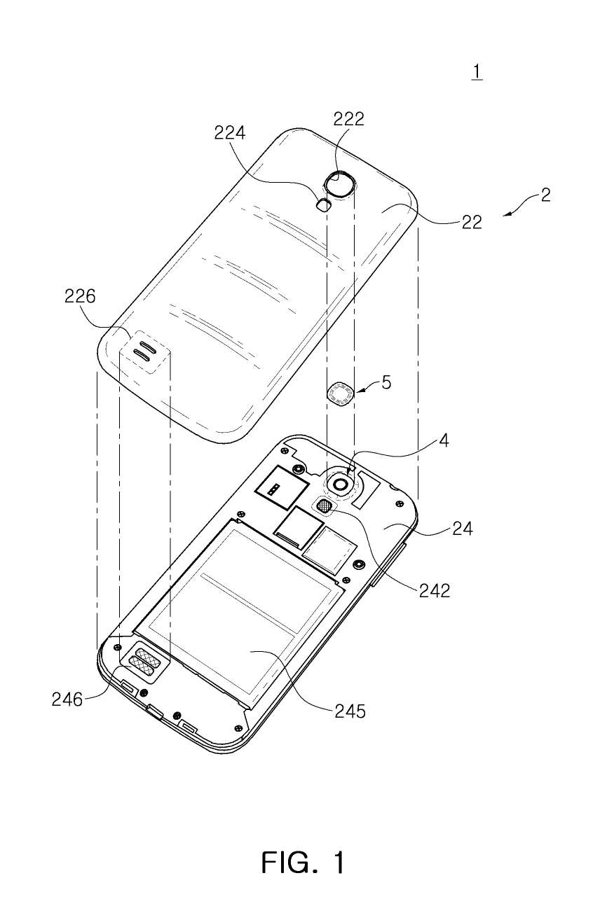

FIG. 1 is an exploded perspective view schematically illustrating an electronic device according to an exemplary embodiment of the present disclosure.

Referring to FIG. 1, an electronic component package 1 according to an exemplary embodiment of the present disclosure may include a frame 2, an antenna module 5, and an electronic component module.

The frame 2 may be a case forming an outer surface of the electronic device 1, and the frame 2 according to the present exemplary embodiment may include an external frame formed of a metal. The external frame 22 may be formed by coating a conductor on an outer portion thereof or be formed using a metal.

The frame 2 may further include an internal frame 24 in addition to the external frame 22 formed as a cover.

Electronic component modules such as a battery 245, a camera module 4, a light source part 242, a microphone module 246, and the like, may be mounted in the internal frame 24, and the external frame 22 may be connected to the internal frame 24 in order to protect the electronic component modules. Here, since the camera module 4, the light source part 242, and the microphone module 246 need to be exposed to the outside of the external frame 22, the respective openings 222, 224, and 226 may be formed in the external frame 22.

In the case in which a current flows in the antenna module 5, an Eddy current may be generated in the external frame 22 formed of the metal, which may cause deteriorations in communications performance with other wireless electronic apparatuses, near field communications devices, and the like, with which the electronic device 1 according to the present exemplary embodiment is to communicate.

Here, the antenna module 5 is disposed in a position corresponding to the opening 222 in the external frame 22, whereby the deterioration of communications performance due to a metal case may be decreased.

Although the case in which the electronic component module having the antenna module 5 formed therein is the camera module 4 has been shown in FIG. 1, the electronic component module is not limited thereto. That is, a separate antenna module 5 may also be formed in the internal frame 24.

In addition, the antenna module 5 may be formed in the camera module 4, the light source part 242, or the microphone module 246 or may be formed in a combined component of the camera module 4 and the light source part 242.

The electronic device 1 according to the present exemplary embodiment may include all electronic component modules to be described below.

### Antenna Module

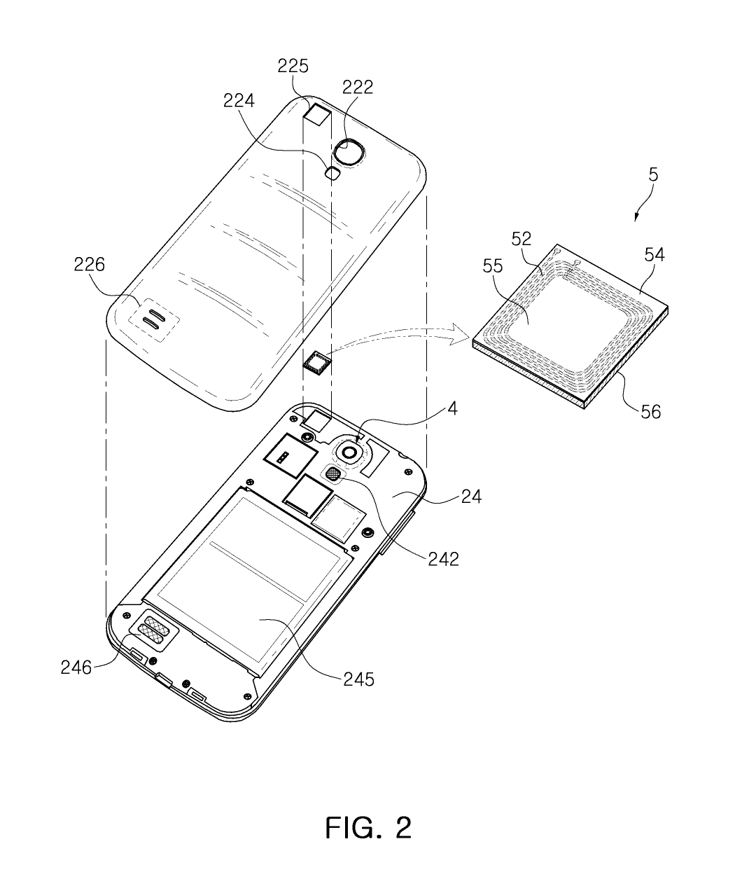

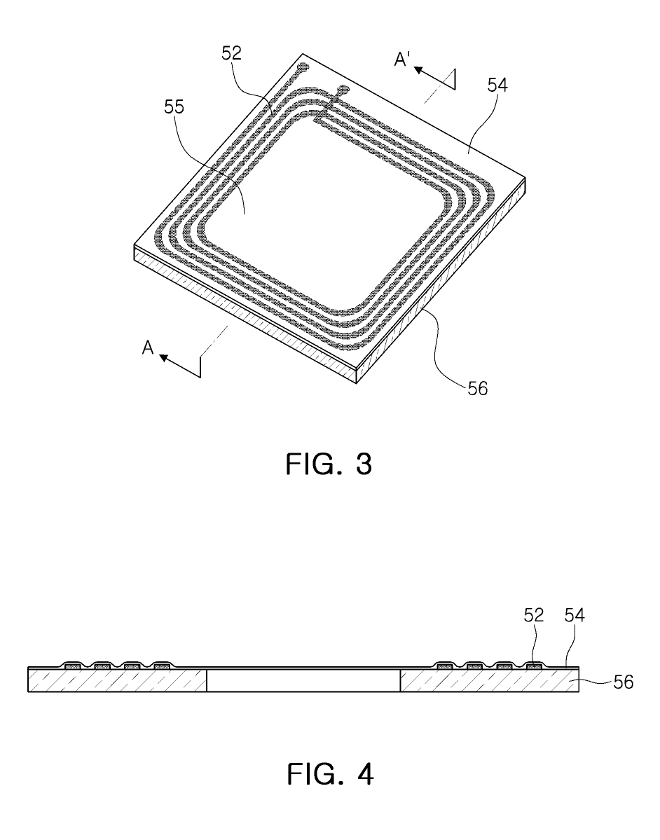

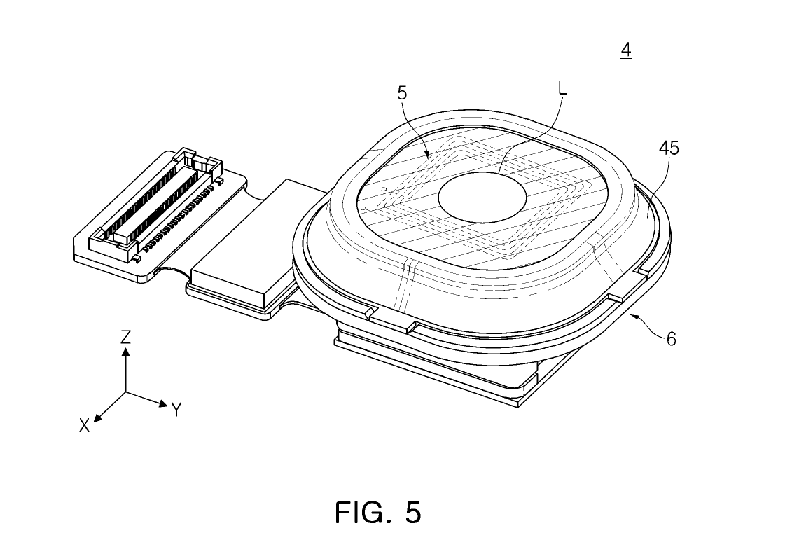

FIG. 2 is a schematic exploded perspective view of the electronic device having an antenna module according to an exemplary embodiment of the present disclosure installed therein; FIG. 3 is a schematic perspective view of the antenna module according to an exemplary embodiment of the present disclosure; and FIG. 4 is a cross-sectional view taken along line A-A′ of FIG. 3.

Referring to FIGS. 2 through 4, an electronic component module according to the present exemplary embodiment may be the antenna module 5 formed by modularizing an antenna conductor.

The antenna module 5 may also be disposed in a position corresponding to a separate opening 225 in the external frame 22 of the electronic device 1.

The antenna module 5 may include a coil conductor part 52 and a flexible substrate 54 having the coil conductor part 52 formed thereon, wherein the flexible substrate 54 having the coil conductor part 52 formed thereon may be formed on a module sheet 56.

The coil conductor part 52 may be wound outside a non-conductive portion 55 of the flexible substrate 54.

The antenna module 5 as described above may be disposed in the internal frame 24 depending on the selection of those skilled in the art. In addition, when viewed on a plane, the coil conductor part 52 may be disposed in the opening 225 of the external frame 22 formed of the metal.

Although the case in which the coil conductor part 52 is formed on the flexible substrate 54 by a method such as a plating method, an etching method, a printing method, or the like, has been shown and described in an exemplary embodiment of the present disclosure, a conductive wire formed of copper, nickel, iron, or the like, may also be formed on the module sheet 56.

In addition, the flexible substrate 54 having the coil conductor part 52 formed thereon may be injection-molded using a resin or a magnetic material to thereby be formed as a single module.

Meanwhile, in order to use the antenna module 5 as a near field communications (NFC) antenna module for near field communications, the module sheet 56 may be a magnetic material sheet.

The magnetic material sheet may contain at least one of Ni—Zn—Cu-based ferrite, Mn—Zn-based ferrite, and Ni, Fe, Co-based amorphous metals.

In addition, the magnetic material sheet may contain at least one of chlorinated polyethylene (CPE), polypropylene (PP), ethylene propylene rubber (EPDM), natural rubber (NR), nitrile butadiene rubber (NBR), polyvinyl chloride (PVC), a polyimide-based resin, and a polyester-based resin. Further, the magnetic material sheet may contain at least one of polyethylene (PE), polystyrene (PS), polyethylene terephthalate (PET), polyamide (PA), polyurethane (PU), polycarbonate (PC), polyvinylidene chloride (PVDC), epoxy, and ABS-based reins.

### Camera Module

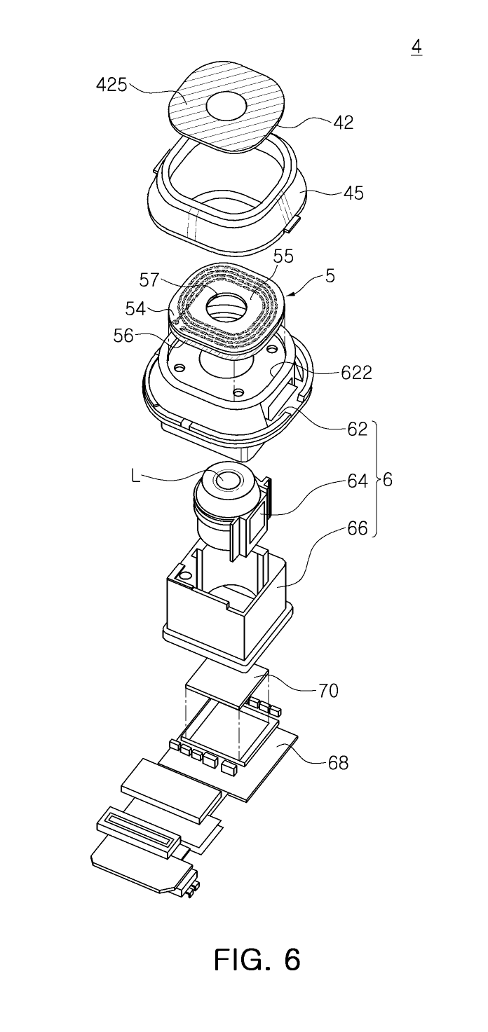

FIG. 5 is a schematic perspective view of a camera module according to a first exemplary embodiment of the present disclosure; and FIG. 6 is a schematic exploded perspective view of the camera module of FIG. 5.

Referring to FIGS. 5 and 6, a camera module 4 according to a first exemplary embodiment of the present disclosure may include a lens housing 6, a window panel 42, and a coil conductor part 52.

The lens housing 6, an exterior part in which a lens L is arranged in an optical axis direction, may include a lens barrel 64 in which the lens L is fixed, upper and lower housings 62 and 66 in which the lens barrel 64 is accommodated, and a board 68 on which an image sensor 70 is mounted.

The camera module according to the present exemplary embodiment may include the window panel 42 covering the lens housing.

The window panel 42 may cover the upper housing 62 in order to protect the lens L from a penetration hole formed in the upper housing 62.

The upper housing 62 may have a seating groove 622 formed therein in order to stably seat the window panel 42 thereon.

In addition, a protecting cover part 45 may be coupled to the upper housing 62 in order to stably fix the window panel 42.

The protecting cover part 45 may internally contact an outer surface of the upper housing 62 to prevent external foreign objects from being introduced into the lens housing 6. The protecting cover part 45 may be omitted if necessary.

The coil conductor part 52 may be formed on the flexible substrate 54 and be used as a component of the antenna module 5 described above. The module sheet 56 formed of the magnetic material may also be formed beneath the flexible substrate 54. When the module sheet 56 formed of the magnetic material is not used, the upper housing 62 may be used as an injection-molded body formed of a magnetic material.

Here, a description for the magnetic material and the antenna module 5 will be replaced by the above-mentioned description. However, the non-conductive portion of the antenna module 5 according to the present exemplary embodiment may have a penetration hole 57 formed therein in order to expose the lens L.

When viewed on a plane, the coil conductor part 52 may be formed between an outer side of the lens L and an inner side of the window panel 42 and may transmit or receive signals.

The window panel 42 may have a shielding coating layer 425 formed thereabove in order to prevent the coil conductor part 52 from being exposed to the outside, wherein the shielding coating layer 425 has a black color. The center of the shielding coating layer 425 may not be coated with the black color in order to expose the lens L.

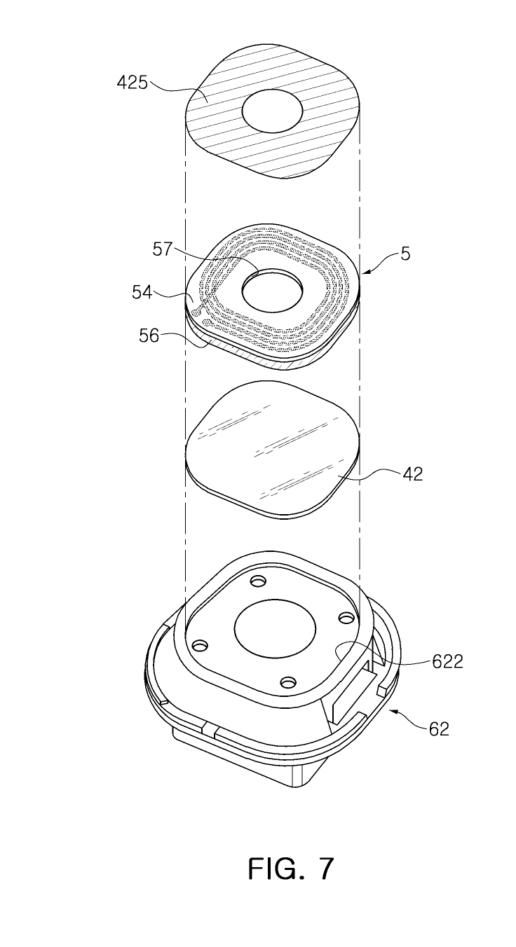

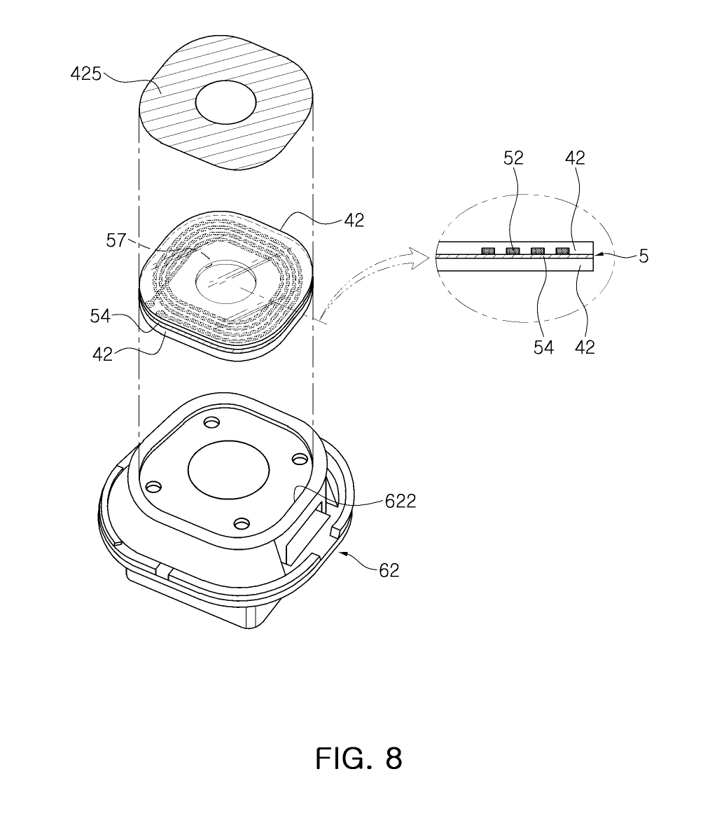

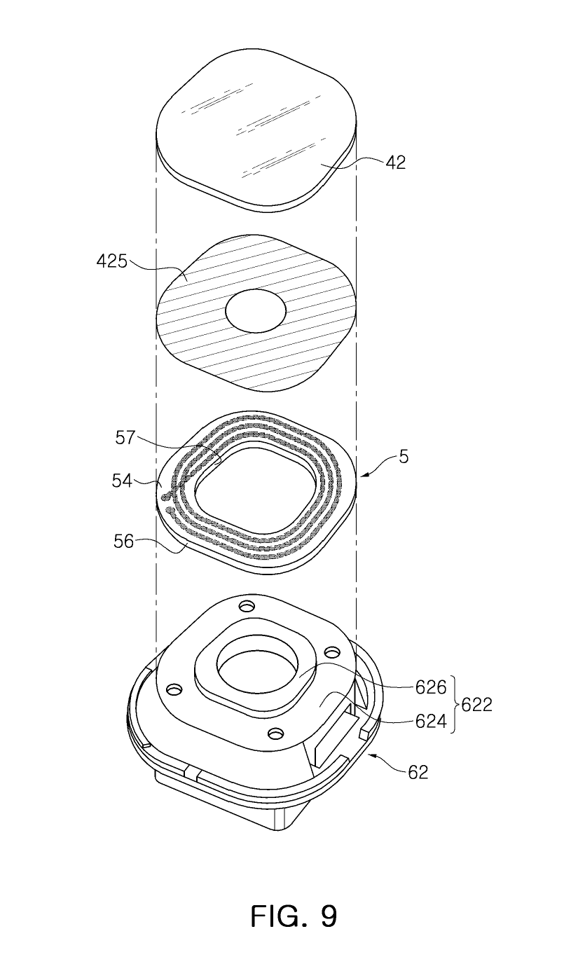

FIG. 7 is a schematic enlarged view of a first modified example of the camera module according to a first exemplary embodiment of the present disclosure; FIG. 8 is a schematic enlarged view of a second modified example of the camera module according to a first exemplary embodiment of the present disclosure; and FIG. 9 is a schematic enlarged view of a third modified example of the camera module according to a first exemplary embodiment of the present disclosure.

Referring to FIG. 7, the antenna module 5 including the coil conductor part 52 may be formed above the window panel 42. In this case, the shielding coating layer 425 may be formed above the antenna module 5 in order to prevent the coil conductor part 52 from being exposed.

Referring to FIG. 8, the coil conductor part 52 may be injection-molded and embedded in the window panels 42. The coil conductor part 52 may be formed integrally with the window panels 42, and may be embedded between the window panels 42 or be formed on surfaces of the window panels 42.

Referring to FIG. 9, the upper housing 62 may have a seating groove 624 formed in an edge thereof so that the coil conductor part 52 is seated thereon, and the coil conductor part 52 may be formed on the flexible substrate 54 having a penetration hole 57 formed therein, the penetration hole 57 having a protruding part 626 penetrating therethrough and the protruding part 626 being formed by the seating groove 624.

In this case, in order to seat the window panel 42, a height of the protruding part 626 and a height of the antenna module 5 may be substantially the same as each other.

Here, the upper housing 62 may be an injection-molded body injection-molded using a magnetic material, and the coil conductor part 52, a metal conducting wire, may be wound around the upper housing 62.

The shielding coating layer 425 may be disposed below the window panel 42 in order to prevent the shielding coating layer 425 from being stripped due to an external contact.

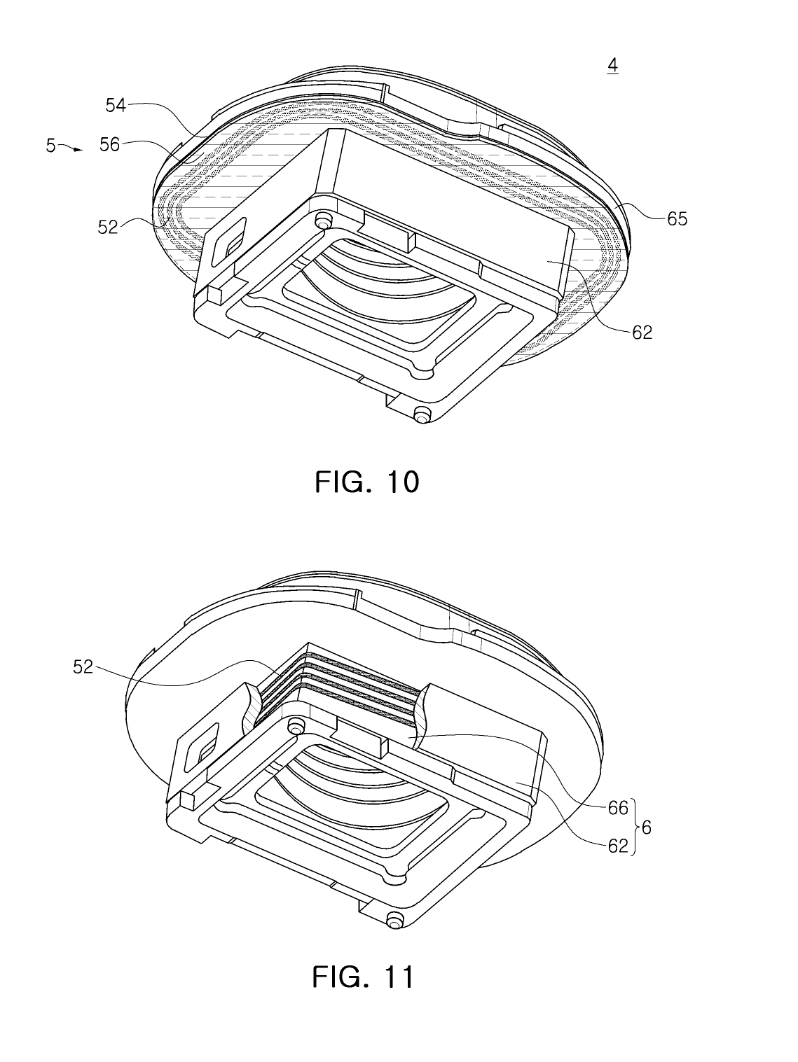

FIG. 10 is a schematic perspective view of a camera module according to a second exemplary embodiment of the present disclosure; and FIG. 11 is a schematic perspective view of a camera module according to a third exemplary embodiment of the present disclosure.

Referring to FIG. 10, the upper housing 62 according to the present exemplary embodiment may have a shoulder part 65 protruding therefrom in a direction perpendicular to the optical axis direction. The shoulder part 65 may have the coil conductor part 52 formed on an upper surface or a lower surface thereof. Since the coil conductor part 52 may have a conductor pattern having a relatively long length, it may serve as an antenna receiving a wide band signal.

Referring to FIG. 11, the coil conductor part 52 may be wound and formed in the optical axis direction of the lens housing 6. The coil conductor part 52 may have a structure of a conductor pattern formed on the flexible substrate 54 and may be formed by winding a conducting wire around the lens housing 6 in the optical axis direction as shown in FIG. 11.

The lens housing 6 around which the coil conductor part 52 is wound may contain a magnetic material to implement an NFC module appropriate for near field communications.

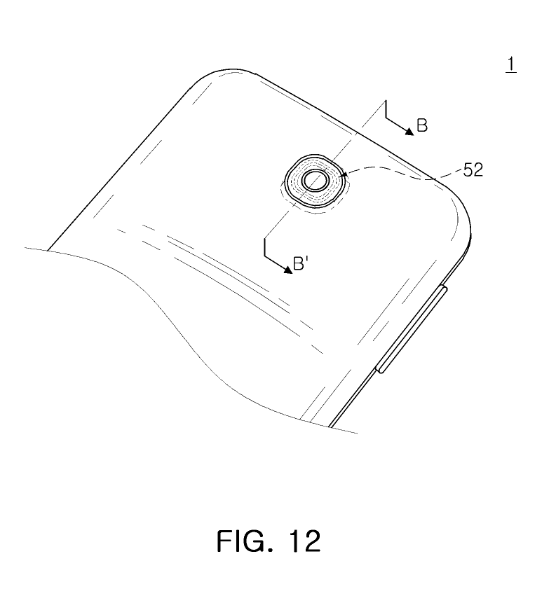

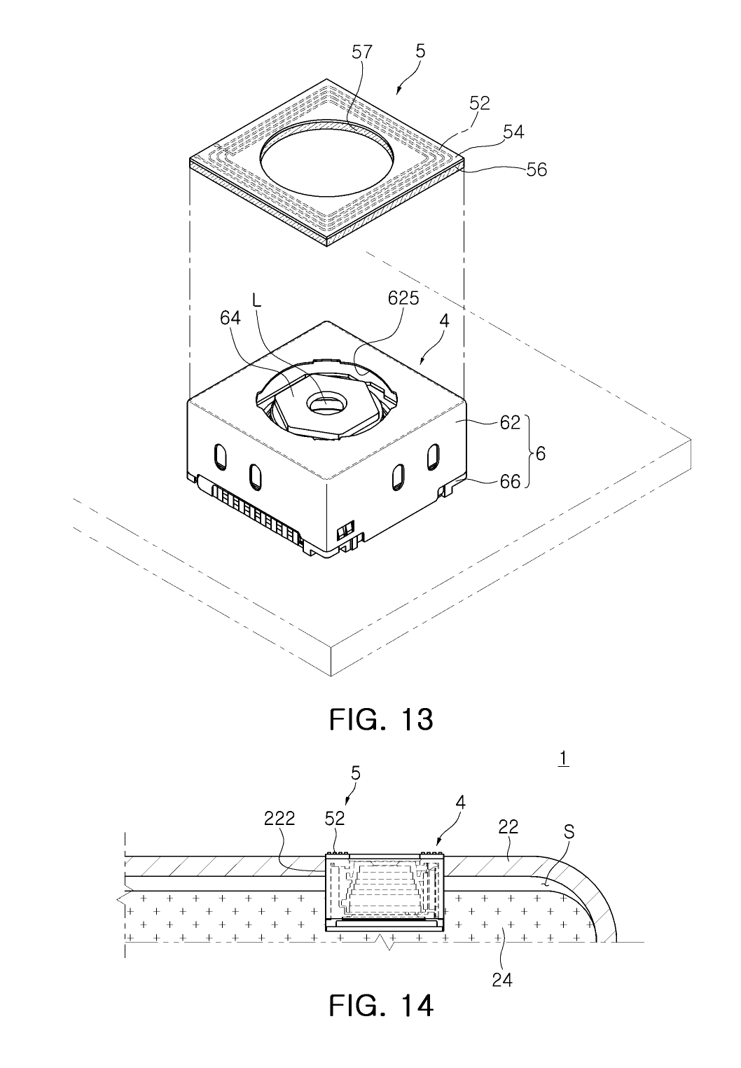

FIG. 12 is a schematic perspective view of an electronic device in which a camera module according to a fourth exemplary embodiment of the present disclosure is used; FIG. 13 is a schematic perspective view of the camera module according to a fourth exemplary embodiment of the present disclosure; and FIG. 14 is a cross-sectional view taken along line B-B′ of FIG. 12.

The electronic device may include a module case 62 coupled to a lens housing 66 according to an exemplary embodiment shown in FIG. 13 and having a penetration hole 625 formed therein so that the lens is exposed to light. Here, the module case 62 may be a shield can for shielding an electromagnetic wave.

The module case 62 may have the antenna module 5 installed on an upper surface thereof, wherein the antenna module 5 includes the coil conductor part 52 formed outside the penetration hole 625 and transmitting or receiving signals.

The coil conductor part 52 may be formed outside a substrate hole 57 on one surface of the flexible substrate 54 in which the substrate hole 57 corresponding to the penetration hole 625 is formed, and the magnetic material sheet 56 may be further formed on the other surface of the flexible substrate 54.

The electronic device according to the present exemplary embodiment will be again described with reference to FIGS. 12 and 14.

The camera module 4 may contact the opening 222 of the external frame 22 formed of the metal to close the opening 222. That is, the camera module 4 may be formed to block a space formed by the opening 222 from being in communication with an internal space S of the external frame 22.

In addition, the coil conductor part 52 may be exposed to the outside of the opening 222 to first contact other communications mechanisms as compared with the opening 222. A structure of the electronic device may be applied to the present exemplary embodiment and other camera modules or electronic component modules.

As set forth above, with the antenna module and the electronic device including the same according to an exemplary embodiment of the present disclosure, an unnecessary opening such as a slit may be omitted from a metal case, such that a degree of freedom in a design of an external case may be increased.

In addition, the coil conductor part is disposed in the opening, whereby wireless communications may be enabled even though a radius of the coil conductor part is decreased.

Further, the housing of the camera module is implemented using the magnetic material, whereby near field communications performance may be improved.

While exemplary embodiments have been shown and described above, it will be apparent to those skilled in the art that modifications and variations could be made without departing from the spirit and scope of the present disclosure as defined by the appended claims.

What is claimed is:

1. An antenna module formed to correspond to an opening formed in a frame, comprising:
a coil conductor part disposed in the opening of the frame when viewed on a plane; and
a substrate including the coil conductor part formed thereon.

2. The antenna module of claim 1, wherein the coil conductor part is wound outside a non-conductive portion of the substrate.

3. The antenna module of claim 1, wherein the coil conductor part is exposed to an upper portion of the opening.

4. The antenna module of claim 1, wherein the substrate further includes a magnetic material sheet.

5. The antenna module of claim 4, wherein the magnetic material sheet contains at least one of Ni—Zn—Cu-based ferrite, Mn—Zn-based ferrite, and Ni, Fe, Co-based amorphous metals.

6. The antenna module of claim 5, wherein the magnetic material sheet contains at least one of chlorinated polyethylene (CPE), polypropylene (PP), ethylene propylene rubber (EPDM), natural rubber (NR), nitrile butadiene rubber (NBR), polyvinyl chloride (PVC), a polyimide-based resin, and a polyester-based resin.

7. The antenna module of claim 1, wherein the coil conductor part is formed in a camera module.

8. The antenna module of claim 1, wherein the coil conductor part is formed in a microphone module.

9. The antenna module of claim 1, wherein the coil conductor part is formed in a light source part.

10. The antenna module of claim 1, wherein the frame is formed of a metal.

11. An electronic device comprising:
a frame having an opening formed therein;
an antenna module disposed in the opening when viewed on a plane and including a coil conductor part transmitting or receiving signals; and
an electronic component module having the coil conductor part formed therein and blocking a space of the opening from being in communication with an internal space of the frame.

12. The electronic device of claim 11, wherein the coil conductor part is wound outside a non-conductive portion of a substrate.

13. The electronic device of claim 12, wherein the coil conductor part protrudes and is exposed from the opening.

14. The electronic device of claim 12, wherein the antenna module further includes a magnetic material sheet formed on the substrate.

15. The electronic device of claim 14, wherein the magnetic material sheet contains at least one of Ni—Zn—Cu-based ferrite, Mn—Zn-based ferrite, and Ni, Fe, Co-based amorphous metals.

16. The electronic device of claim 15, wherein the magnetic material sheet contains at least one of chlorinated polyethylene (CPE), polypropylene (PP), ethylene propylene rubber (EPDM), natural rubber (NR), nitrile butadiene rubber (NBR), polyvinyl chloride (PVC), a polyimide-based resin, and a polyester-based resin.

17. The electronic device of claim 11, wherein the electronic component module includes a camera module, a light source part, or a combination thereof.

18. The electronic device of claim 11, wherein the electronic component module includes a microphone module.

19. The electronic device of claim 11, wherein the electronic component module includes an antenna module in which an antenna conductor part is injection-molded using a magnetic material.

20. The electronic device of claim 11, wherein the frame is formed of a metal.
